(19) United States
(12) Patent Application Publication
(10) Pub. No.: US 2026/0088415 A1
(43) Pub. Date: Mar. 26, 2026

(54) BATTERY DEVICE

(71) Applicant: SK ON CO., LTD., Seoul (KR)

(72) Inventors: Jin-Su HAN, Daejeon (KR); Min-Song KANG, Daejeon (KR); Ji-Woong KIM, Daejeon (KR); Byeong-Jun PAK, Daejeon (KR); Ju-Yong PARK, Daejeon (KR); Suk-Ho SHIN, Daejeon (KR)

(21) Appl. No.: 19/109,560

(22) PCT Filed: Jun. 15, 2023
(86) PCT No.: PCT/KR2023/008236

§ 371 Date: Mar. 7, 2025

(30) Foreign Application Priority Data
Nov. 9, 2022 (KR) 10-2022-0148486

(51) Int. Cl. H01M 50/242; H01M 50/204; H01M 50/264; H01M 50/293; H01M 50/298; H01M 50/514; H01M 50/588; H01M 50/591

(52) U.S. Cl. CPC H01M 50/242; H01M 50/204; H01M 50/264; H01M 50/293; H01M 50/298; H01M 50/514; H01M 50/588; H01M 50/591

(57) ABSTRACT

A battery device according to an embodiment of the present invention comprises a plurality of cell stacks electrically interconnected by connection members, a case containing the plurality of cell stacks therein, and support members disposed between the connection members and the case so as to support the case, wherein the support members may comprise: shock-absorbing bodies made of an insulating material and having first insertion grooves, into which the connection members are inserted, formed on first surfaces thereof; conductive wires inserted into second insertion grooves formed on second surfaces of the shock-absorbing bodies and electrically connected to at least one cell stack; and insulating covers coupled to the second surfaces of the shock-absorbing bodies.

### TECHNICAL FIELD

The present disclosure relates to a battery device having ease in the manufacturing thereof.

### BACKGROUND ART

Recently, a high-power battery device using a non-aqueous electrolyte having high-energy density has been developed. For use in motor driving of a device requiring high power, e.g., an electric vehicle, etc., the high-power battery device has been implemented with high capacity by connecting a plurality of battery cells or devices in series or in parallel.

A conventional battery device includes a cell monitoring unit (CMU) monitoring a voltage/temperature of each battery cell, a battery management unit (BMU) monitoring the battery device in overall by collecting information monitored by the CMU, and at least one conductive wire for electrically connecting the CMU to the BMU.

A plurality of conductive wires may be coupled to the battery device in a manufacturing process, requiring much time to fix the conductive wires in the battery device. Accordingly, there is a need for a structure to stably and quickly fix the conductive wires.

### SUMMARY OF INVENTION

### Technical Problem

An aspect of the present disclosure is to provide a battery device having ease in the manufacturing thereof.

Another aspect of the present disclosure is to provide a battery device that is capable of stably and quickly fixing a conductive wire.

### Solution to Problem

According to an aspect of the present disclosure, a battery device includes a plurality of cell stacks electrically connected to each other by a connection member, a case accommodating the plurality of cell stacks therein, and a support member arranged between the connection member and the case to support the case. The support member includes a shock-absorbing body formed of an insulating material and having formed on a first surface thereof, a first insertion groove into which the connection member is inserted, a conductive wire inserted into a second insertion groove formed on a second surface of the shock-absorbing body and electrically connected to at least some of the plurality of cell stacks, and an insulating cover coupled to the second surface of the shock-absorbing body.

In the current embodiment, the insulating cover may extend to surround at least one of side surfaces of the shock-absorbing body.

In the current embodiment, two connection members may be arranged side by side, and at least a portion of the insulating cover may be arranged between the two connection members.

In the current embodiment, the connection member may be fastened to the plurality of cell stacks through a fastening member, and the shock-absorbing body may include an expanded groove into which the fastening member protruding outside the connection member is inserted.

In the current embodiment, the shock-absorbing body may be fitted to the fastening member.

In the current embodiment, the shock-absorbing body may be formed of expanded polypropylene (EPP).

In the current embodiment, the insulating cover may be formed of a sheet including a mica.

In the current embodiment, the second insertion groove may be formed as a groove in a shape of a slot.

In the current embodiment, a connector coupled to the plurality of cell stacks may be formed on both end portions of the conductive wire.

In the current embodiment, a plurality of first insertion grooves may be arranged spaced apart from each other, the shock-absorbing body may further include a third insertion groove arranged in a shape of a slit between the first insertion grooves, and at least a portion of the insulating cover may be arranged to be inserted into the third insertion groove.

According to another aspect of the present disclosure, a battery device includes a plurality of cell stacks electrically connected to each other by a connection member, a case accommodating the plurality of cell stacks therein, and a support member arranged between the connection member and the case. The support member is coupled to the connection member to completely cover a top surface of the connection member so as to secure insulation between the connection member and the case, and a top surface of the support member is arranged to surface-contact the case so as to suppress shaking of the case.

In the current embodiment, the battery device may further include a conductive wire having a portion embedded in the support member and both ends exposed to an outside of the support member, the both ends of the conductive wire being respectively coupled to the plurality of cell stacks.

### Advantageous Effects of Invention

According to an aspect of the present disclosure, a support member is arranged between a cell stack and a case to surround connection members for suppression of shaking or trembling of an top plate, thereby preventing a short-circuit of the connection members in a thermal runaway situation.

Moreover, the conductive wire may be fixedly arranged at a correct position by merely coupling the support member to the connection member in a battery device manufacturing process, thereby reducing a manufacturing process and a manufacturing time.

### BRIEF DESCRIPTION OF DRAWINGS

FIG. 1 is an exploded perspective view schematically illustrating a battery device according to an embodiment of the present disclosure.

FIG. 2 is a partial exploded perspective view of FIG. 1.

FIG. 3 is an enlarged view of a support member illustrated in FIG. 2.

FIG. 4 is an exploded perspective view of FIG. 3.

FIG. 5 is a bottom perspective view of FIG. 3.

FIG. 6 is an enlarged view of a portion A of FIG. 2.

FIG. 7 is an enlarged view of a portion B of FIG. 2.

FIG. 8 is an exploded perspective view showing a support member according to another embodiment of the present disclosure.

FIG. 9 is a bottom perspective view of a support member illustrated in FIG. 8.

### MODE FOR INVENTION

Hereinafter, embodiments of the present disclosure will be described in detail with reference to the accompanying drawings. In the accompanying drawings, some components are exaggerated, omitted, or schematically shown, and the size of each component does not entirely reflect the actual size thereof.

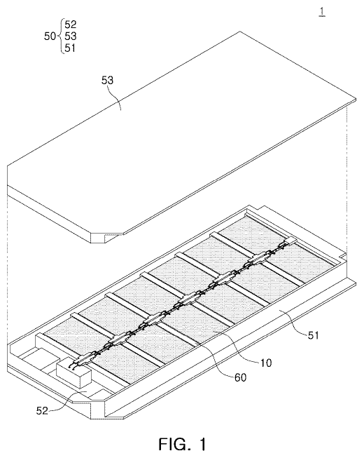

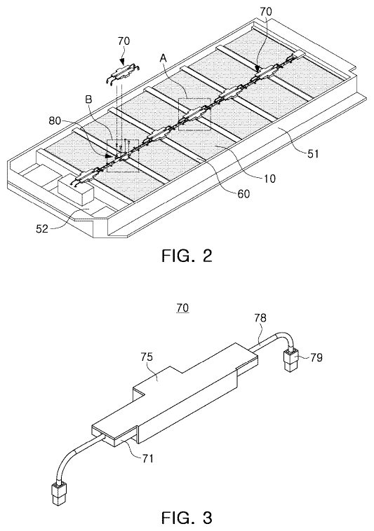

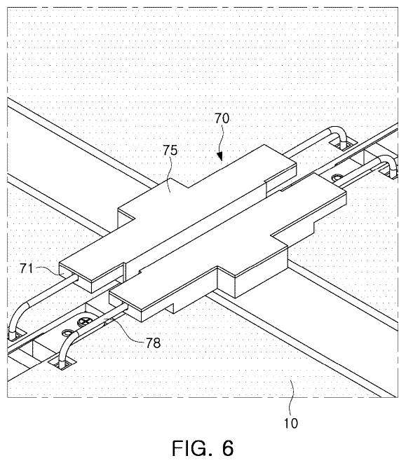

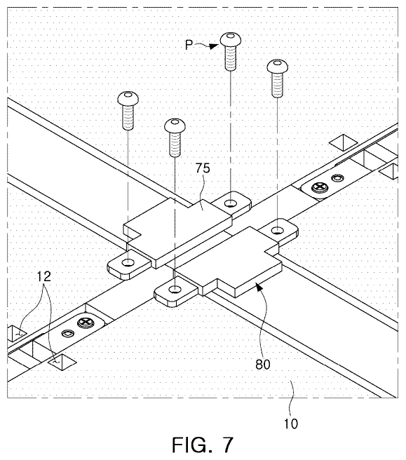

FIG. 1 is an exploded perspective view schematically illustrating a battery device according to an embodiment of the present disclosure, and FIG. 2 is a partial exploded perspective view of FIG. 1. FIG. 6 is an enlarged view of a portion A of FIG. 2, and FIG. 7 is an enlarged view of a portion B of FIG. 2.

Referring to FIGS. 1, 2, 6, and 7, a battery device 1 according to an embodiment of the present disclosure may include a plurality of cell stacks 10, a case 50, a partition wall 60, a connection member 80, and a support member 70.

The cell stack 10 may include a secondary battery cell such as a lithium battery, a nickel metal hydride battery, etc., that is chargeable and dischargeable. Each cell stack 10 may be formed by stacking a plurality of battery cells in the shape of a hexahedron and a stacked state thereof may be fixed by being accommodated in a separate module case or by a bracket, etc.

The cell stack 10 may be provided with at least one terminal on a side surface thereof. The terminal may be a conductive member provided on the cell stack 10 to electrically connect the battery cells to the outside. The terminal may include a positive terminal and a negative terminal, and the respective cell stacks 10 may be electrically connected to each other through the connection member 80 fastened to the terminal.

The case 50 may provide an accommodation space for accommodating other components therein. Thus, the case 50 may be provided to surround all of the cell stacks 10, and the plurality of cell stacks 10 may be arranged side by side, forming a plurality of columns in the accommodation space of the case 50.

The case 50 may be formed of, but not limited to, a metal material to secure rigidity. To improve the effect of heat dissipation, at least a portion of the case 50 may be formed of aluminum.

The case 50 may include a sidewall part 51 forming an internal space, a bottom plate 52 covering a bottom of the internal space, and a top plate 53 covering a top of the internal space.

The sidewall part 51 may define the internal space while forming an outer surface of the case 50. Thus, the cell stacks 10 may be accommodated in the internal space defined by the sidewall part 51 and may be placed on the bottom plate 52.

The bottom plate 52 may support a bottom surface of the cell stacks 10 and at the same time, cool the cell stacks 10.

In the case 50 may be provided the partition wall 60 arranged across the internal space formed by the sidewall part 51 to divide the internal space into a plurality of accommodation spaces. Thus, at least a portion of the partition wall 60 may be fastened to the sidewall part 51.

The partition wall 60 may be coupled to the case 50 to reinforce the overall rigidity of the case 50. The partition wall 60 may also be arranged between the cell stacks 10 to suppress propagation of gas or flames between the cell stacks 10.

In the current embodiment, the partition wall 60 may be arranged between two cell stacks 10 arranged side by side. The partition wall 60 may be fastened to the sidewall part 51 of the case 50 or with another partition wall 60, at both ends thereof, to divide the internal space formed by the sidewall part 51 into the plurality of accommodation spaces.

The plurality of cell stacks 10 may be arranged in a distributed manner in the plurality of accommodation spaces divided by the sidewall part 51 and the partition wall 60.

The partition wall 60 may be welded to the case 50 or fixedly fastened to the case 50 through a fastening means such as a bolt, a screw, etc.

The connection member 80 may be formed of a conductive material to electrically connect a terminal of any one cell stack 10 to a terminal of another cell stack 10 adjacent thereto. To this end, the connection member 80 may include a bus bar or a cable. The connection member 80 may be fastened on both end portions thereof to terminals of the cell stacks 10 through a fastening member P such as a bolt.

The cell stacks 10 according to the current embodiment may be connected to each other in series or in parallel through the connection member 80. Depending on need, some of the cell stacks 10 may be connected in series and some others may be connected in parallel.

The connection member 80 according to the current embodiment may be formed by processing a conductive member in the shape of a flat rod. The connection member 80 may be formed of a material having flexibility. However, a structure of the present disclosure is not limited thereto.

Referring to FIG. 7, the connection members 80 according to the current embodiment may be arranged in pairs such that two of them face each other. However, a structure of the present disclosure is not limited thereto.

The support member 70 may be arranged between the connection member 80 and the top plate 53 and may accommodate at least a portion of the connection member 80 therein.

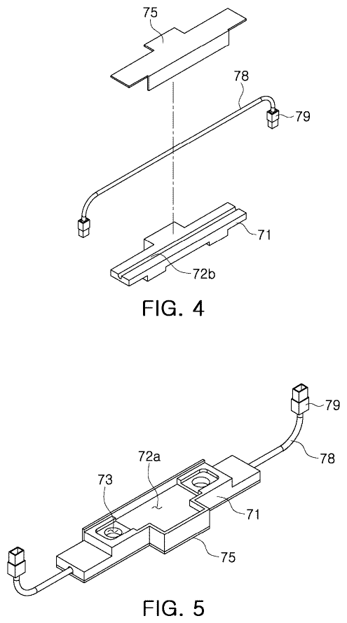

FIG. 3 is an enlarged view of a support member illustrated in FIG. 2, FIG. 4 is an exploded perspective view of FIG. 3, and FIG. 5 is a bottom perspective view of FIG. 3.

Referring to FIGS. 3 to 5 together, the support member 70 according to the current embodiment may include a conductive wire 78, a shock-absorbing body 71, and an insulating cover 75.

The conductive wire 78 may include a wire formed by insulation-coating a conductor, and at least one of both end portions thereof may be coupled to the cell stack 10. To this end, a connector 79 may be coupled to the both end portions of the conductive wire 78. The connector 79 may be coupled to a connector coupling portion 12 provided on the cell stack 10, such that the conductive wire 78 may be electrically connected to the cell stack 10.

The conductive wire 78 may be used to connect cell monitoring units (CMUs) monitoring a voltage/temperature of a battery cell to each other or to electrically connect a battery management unit (BMU) collecting information monitored by the CMUs to manage a battery device in overall to the CMUs. However, the present disclosure is not limited thereto.

The shock-absorbing body 71 may be coupled to the connection member 80. To this end, a bottom surface that is a first surface of the shock-absorbing body 71 may be provided with a first insertion groove 72a into which the connection member 80 is inserted.

The first insertion groove 72a may be formed as a groove corresponding to the shape of the connection member 80, such that the connection member 80 may be partially or entirely inserted into the first insertion groove 72a.

The first insertion groove 72a may be coupled to the connection member 80 to completely cover a top surface of the connection member 80. Thus, when the connection member 80 is coupled to the shock-absorbing body 71, the connection member 80 may not be exposed to outside the shock-absorbing body 71.

In the current embodiment, the connection member 80 may be coupled to the cell stack 10 through the fastening member P such as a bolt. Thus, at least a portion of the fastening member P may protrude upwardly from the connection member 80.

Thus, the shock-absorbing body 71 may include an expanded groove 73 into which the fastening member P is inserted. The expanded groove 73 may be formed corresponding to a position at which the fastening member P is arranged. A horizontal cross-sectional area of the expanded groove 73 may be equal to or slightly less than a horizontal cross-sectional area of the fastening member P. In this case, the fastening member P may be tightly inserted into the expanded groove 73 without any margin, thus being stably coupled to the connection member 80 without a separate fixing member.

A top surface that is a second surface of the shock-absorbing body 71 may be provided with a second insertion groove 72b.

The conductive wire 78 may be inserted into the second insertion groove 72b. Thus, the second insertion groove 72b may be formed in the shape of a long slot, and a width of the second insertion groove 72b may be defined corresponding to a thickness of the conductive wire 78.

To firmly couple the conductive wire 78 to the second insertion groove 72b, the width of the second insertion groove 72b like the expanded groove 73 may be equal to or slightly less than the thickness of the conductive wire 78.

The shock-absorbing body 71 may be formed of a material having electric insulation and may be formed of a material elastically deformed by an external force. Thus, when the fastening member P is inserted into the expanded groove 73, the shock-absorbing body 71 may be elastically deformed and a cross-sectional area of the expanded groove 73 may be expanded, and when the fastening member P is completely inserted into the expanded groove 73, the shock-absorbing body 71 may press the fastening member P through restoring force. Likewise, when the conductive wire 78 is inserted into the second insertion groove 72b, the shock-absorbing body 71 may be elastically deformed and the width of the second insertion groove 72b may increase, and when the conductive wire 78 is completely inserted into the second insertion groove 72b, the shock-absorbing body 71 may press the conductive wire 78 through restoring force. Thus, the fastening member P inserted into the expanded groove 73 or the conductive wire 78 inserted into the second insertion groove 72b may not be easily separated from the shock-absorbing body 71. Such a structure may also be equally applied to the first insertion groove 72a.

The shock-absorbing body 71 may be formed of a foaming material. When the top surface of the support member 70 is arranged to closely surface-contact the case 50, the support member 70 may absorb shaking or trembling of the case 50. Thus, shaking of the case 50 may be suppressed by the support member 70. For example, the shock-absorbing body 71 may be formed of, but is not limited to, expanded polypropylene (EPP) formed by foaming a polyolefin-based ‘polypropylene (PP)’ material.

The insulating cover 75 may be coupled to the second surface of the shock-absorbing body 71.

The insulating cover 75 may be coupled to the shock-absorbing body 71 to cover the conductive wire 78 inserted into the second insertion groove 72b. Thus, the conductive wire 78 inserted into the second insertion groove 72b may not be easily separated from the second insertion groove 72b by the insulating cover 75.

The insulating cover 75 may be formed to surround at least one of side surfaces of the shock-absorbing body 71. For examples, as illustrated in FIGS. 6 and 7, when two connection members 80 are arranged side by side, at least a portion of the insulating cover 75 may be arranged between two connection members 80. Thus, the insulating cover 75 may be arranged on a side surface facing another connection member 80 among the side surfaces of the shock-absorbing body 71. To improve the reliability of insulation between the connection members 80, the insulating cover 75 may be arranged over the entire facing regions of the connection members 80.

The insulating cover 75 may directly contact the top plate 53 of the case 50 and thus may be formed of a material having electric insulation. The insulating cover 75 according to the current embodiment may be formed of a material having a flame retardancy or flame resistance capability to suppress propagation of flames or heat caused by flames to another cell stack 10 in case of thermal runaway. Herein, the flame retardancy capability may mean a capability to prevent spread of combustion, and the flame resistance capability may mean a capability not to burn easily in spite of ignition. Thus, the insulating cover 75 may have combustibility to the extent that the insulating cover 75 is not a factor in the spread of combustion or may have a non-flammable property.

For example, the insulating cover 75 according to the current embodiment may include a mica. Specifically, the insulating cover 75 may be formed by forming a sheet including a mica. The insulating cover 75 may include a sheet. Depending on a need, the insulating cover 75 may also be formed by stacking sheets of different materials.

The insulating cover 75 may be bonded to the shock-absorbing body 71 via an adhesive member. As the adhesive member, an adhesive or an adhesive tape may be used, but the present disclosure is not limited thereto.

The support member 70 according to the current embodiment structured in this way may be arranged to contact the connection member 80 and the top plate 53. For example, the entire top surface of the support member 70 may surface-contact the bottom surface of the top plate 53. As described above, as the shock-absorbing body 71 of the support member 70 is formed of a foaming material, the support member 70 may absorb shaking or trembling of the top plate 53.

A plurality of support members 70 may be arranged in a distributed manner according to an arrangement structure of the cell stacks 10. Thus, in the battery device 1 according to the current embodiment, a plurality of support members 70 support the top plate 53 at several points, thereby preventing a specific part of the top plate 53 from hanging down.

As each support member 70 is arranged to surround each connection member 80 and the insulating cover 75 is arranged between the connection members 80 facing each other, insulation between the connection members 80 may be secured. Consequently, the connection members 80 may be prevented from being short-circuited by contacting each other in a thermal runaway situation.

As the conductive wire 78 is formed integrally with the shock-absorbing body 71, the conductive wire 78 may be fixedly arranged at a correct position merely by coupling the support member 70 according to the current embodiment to the connection member 80 in a manufacturing process of the battery device 1. Hence, the manufacturing process may be simplified, thereby minimizing a manufacturing time.

Meanwhile, the present disclosure is not limited to the above-described embodiment, and various modifications may be possible.

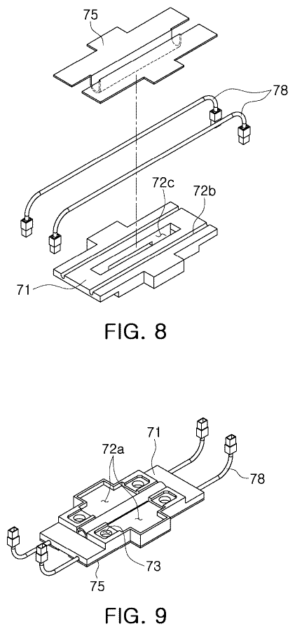

FIG. 8 is an exploded perspective view showing a support member according to another embodiment of the present disclosure, and FIG. 9 is a bottom perspective view of a support member illustrated in FIG. 8.

Referring to FIGS. 8 and 9, in the support member 70 according to the current embodiment, the plurality of connection members 80 of FIG. 7 may be coupled to the first surface of the shock-absorbing body 71, and the plurality of conductive wires 78 may be coupled to the second surface of the shock-absorbing body 71. Thus, a plurality of first insertion grooves 72a may be provided corresponding to an arrangement structure of the plurality of connection members 80, and a plurality of second insertion grooves 72b may be provided to allow the plurality of conductive wires 78 to be coupled thereto.

In the shock-absorbing body 71 according to the current embodiment may be provided a third insertion groove 72c into which the insulating cover 75 is inserted between two first insertion grooves 72a. The third insertion groove 72c may be formed long in the shape of a slit and may be formed on the entire facing regions of the connection members 80.

The insulating cover 75 may be formed to the entire second surface of the shock-absorbing body 71, and at least a portion of the insulating cover 75 may be formed to be inserted into the third insertion groove 72c.

In the battery device according to the current embodiment structured in this way, one support member 70 may cover the plurality of connection members 80, thereby further shortening the manufacturing time.

Although the embodiments of the present disclosure have been described in detail, the scope of the present disclosure is not limited thereto, and it would be obvious to those of ordinary skill in the art that various modifications and changes are possible without departing from the technical spirit of the present disclosure.

For example, the above-described embodiments have been described using, as an example, a case where the connection members 80 are arranged adjacent to each other, but a case where the connection member 80 is arranged adjacent to the sidewall part 51 of the case 50 may also be considered. In this case, for insulation between the connection member 80 and the sidewall part 51, at least a portion of the insulating cover 75 may be arranged between the connection member 80 and the sidewall part 51.

In addition, embodiments may be carried out in combination.

1. A battery device comprising:
a plurality of cell stacks electrically connected to each other by a connection member;
a case accommodating the plurality of cell stacks therein; and
a support member arranged between the connection member and the case to support the case,
wherein the support member comprises:
a shock-absorbing body formed of an insulating material and having formed on a first surface thereof, a first insertion groove into which the connection member is inserted;
a conductive wire inserted into a second insertion groove formed on a second surface of the shock-absorbing body and electrically connected to at least some of the plurality of cell stacks; and
an insulating cover coupled to the second surface of the shock-absorbing body.

2. The battery device of claim 1, wherein the insulating cover extends to surround at least one of side surfaces of the shock-absorbing body.

3. The battery device of claim 1, wherein two connection members are arranged side by side, and
at least a portion of the insulating cover is arranged between the two connection members.

4. The battery device of claim 1, wherein the connection member is fastened to the plurality of cell stacks through a fastening member, and
the shock-absorbing body comprises an expanded groove into which the fastening member protruding outside the connection member is inserted.

5. The battery device of claim 4, wherein the shock-absorbing body is fitted to the fastening member.

6. The battery device of claim 1, wherein the shock-absorbing body is formed of expanded polypropylene (EPP).

7. The battery device of claim 1, wherein the insulating cover is formed of a sheet comprising a mica.

8. The battery device of claim 1, wherein the second insertion groove is formed as a groove in a shape of a slot.

9. The battery device of claim 1, wherein a connector coupled to the plurality of cell stacks is formed on both end portions of the conductive wire.

10. The battery device of claim 1, wherein a plurality of first insertion grooves are arranged spaced apart from each other,
the shock-absorbing body further comprises a third insertion groove arranged in a shape of a slit between the first insertion grooves, and
at least a portion of the insulating cover is arranged to be inserted into the third insertion groove.

11. A battery device comprising:
a plurality of cell stacks electrically connected to each other by a connection member;
a case accommodating the plurality of cell stacks therein; and
a support member arranged between the connection member and the case,
wherein the support member is coupled to the connection member to completely cover a top surface of the connection member so as to secure insulation between the connection member and the case, and
a top surface of the support member is arranged to surface-contact the case so as to suppress shaking of the case.

12. The battery device of claim 11, further comprising a conductive wire having a portion embedded in the support member and both ends exposed to an outside of the support member, the both ends of the conductive wire being respectively coupled to the plurality of cell stacks.
